(19) United States
(12) Patent Application Publication
(10) Pub. No.: US 2026/0171709 A1
(43) Pub. Date: Jun. 18, 2026

(54) Locking structure with dustproof and waterproof caps

(71) Applicant: Honglin Electric Power Technology (Thailand) Co., Ltd., Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd., Rayong (TH)

(21) Appl. No.: 18/982,585

(22) Filed: Dec. 16, 2024

(51) Int. Cl. H01R 13/443; H01R 13/52; H01R 13/629; H01R 13/717; H01R 24/22; H01R 103/00

(52) U.S. Cl. CPC H01R 13/443; H01R 13/52; H01R 13/629; H01R 13/717; H01R 24/22; H01R 2103/00

(57) ABSTRACT

The present invention comprises a bottom panel and a cover panel, which cooperate mutually and are in snap-fitted installation, wherein outer portions of both the bottom panel and the cover panel are sleeved with a protective cover, and both the protective cover and the cover panel are provided with socket jacks, the socket jacks are distributed on front and two side portions of the protective cover, a power supply mechanism is installed within the bottom panel and cover panel and is connected to a cable for electrical energy supply, which enables plugs to be inserted into the power supply mechanism through the socket jacks for energy access; and a front inserting mechanism is arranged on a front portion of the bottom panel and connected with the power supply mechanism, and a plug could be inserted from front socket jacks into the front inserting mechanism and be locked.

### TECHNICAL FIELD

The present invention relates to the field of extension cords, specifically to a locking structure with dustproof and waterproof caps.

### BACKGROUND TECHNOLOGY

Extension cords are a kind of power supply devices that can extend distances of power delivery; therefore, usage of extension cords is extremely widespread. Basically, wherever electricity is needed, there are usually extension cords present. As people's demands for electricity have varied, the forms of extension cords have also diversified to meet the needs of users in different scenarios.

Although existing extension cords can satisfy people's electricity demands, there are still some issues. First, current extension cords are not able to provide dust and water protection, as water can easily enter the extension cords through the socket jacks, thereby making potentially damages. Second, current extension cords are not convenient for hanging. Hence, there is a need for a locking structure with dustproof and waterproof caps to address the above issues.

### SUMMARY OF THE INVENTION

The purpose of embodiments of the present invention is to provide a locking structure with dustproof and waterproof caps, aiming to solve the following problems: existing extension cords are unable to offer dust and water protection and are inconvenient for hanging.

Embodiments of the present invention are implemented as follows: a locking structure with dustproof and waterproof caps, comprises a bottom panel and a cover panel, wherein the bottom panel and the cover panel cooperate mutually and are in snap-fitted installation, wherein outer portions of both the bottom panel and the cover panel are sleeved with a protective cover, both the protective cover and the cover panel are provided with socket jacks, and the socket jacks are distributed on front and two side portions of the protective cover; and a power supply mechanism is installed within the bottom panel and cover panel and is connected to a cable for electrical energy supply, which enables plugs to be inserted into the power supply mechanism through the socket jacks for energy access; and a front inserting mechanism is arranged on a front portion of the bottom panel and connected with the power supply mechanism, and a plug could be inserted from front socket jacks into the front inserting mechanism and be locked.

Preferably, the power supply mechanism comprises a support panel arranged in the cover panel and fixedly connected to the bottom panel, wherein a first copper sheet and a second copper sheet are respectively installed on both sides of the support panel, and the first copper sheet and the second copper sheet are connected to the cable, which enables plugs to be inserted into the first copper sheets and the second copper sheets through the socket jacks for power supply; and a grounding panel installed on the bottom panel and connected to the cable, enabling plugs to be inserted into the grounding panel through the socket jacks for grounding purposes.

Preferably, the front inserting mechanism comprises: a support seat fixedly mounted on a front portion of the bottom panel, wherein a lever is rotationally mounted on the support seat, a triangular block is fixedly arranged on the lever, an elastic sheet mounted on the support seat clamped on a back portion of the lever, and the elastic sheet is used to push the lever to reset; a first outer clip fixedly connected to the first copper sheet, wherein a first inner clip is fixedly arranged on the first outer clip; a second outer clip is fixedly connected to the second copper sheet, a second inner clip is fixedly arranged on the second outer clip, the first outer clip and the second outer clip could respectively cooperate with the first inner clip and the second inner clip to limit a plug; and push blocks slidably mounted on the support seat, wherein the amount of the push blocks is two, and the triangular block contacts the two push blocks, so as to push the first outer clip and the second outer clip away mutually to pull out the plug.

Preferably, the locking structure with dustproof and waterproof caps further comprises a power indicator light installed on the protective cover, connected to the first copper sheet and the second copper sheet, and used to indicate power supply status of an extension cord; hanging holes fixedly arranged on a rear side of the protective cover for hanging the extension cord; and waterproof caps sleeved outside the cable and arranged in cooperation with the socket jacks, wherein the waterproof caps are able to be inserted into the socket jacks to provide dust and water protection for the first copper sheets and the second copper sheets.

The locking structure with dustproof and waterproof caps provided by the present invention not only supplies electricity but also be dustproof and waterproof, effectively preventing an extension cord from being affected by water and dust while also facilitating hanging, which is of strong practicality.

### BRIEF DESCRIPTION OF THE DRAWINGS

FIG. 1 is a schematic diagram showing appearance of a locking structure with dustproof and waterproof caps.

FIG. 2 is a schematic diagram showing a bottom panel and a cover panel of the locking structure with dustproof and waterproof caps.

FIG. 3 is a schematic diagram showing inner portions of the locking structure with dustproof and waterproof caps.

FIG. 4 is a partial schematic diagram of a front inserting mechanism of the locking structure with dustproof and waterproof caps.

The markups in the drawings are indicated as follows:
1—bottom panel;
2—cover panel;
3—protective cover;
4—socket jack;
5—power supply mechanism;
6—cable;
51—support panel;
52—first copper sheet;
53—second copper sheet;
54—grounding panel;
7—front inserting mechanism;
71—support seat;
72—lever;
73—triangular block;
74—elastic sheet;
75—first outer clip;
76—first inner clip;
77—second outer clip;
78—second inner clip;
79—push block;
8—power indicator light;
9—hanging hole; and
10—waterproof cap.

### SPECIFIC EMBODIMENTS

In order to make the purpose, technical solutions and advantages of the present invention more clear, the present invention is further described in detail in conjunction with the accompanying drawings and embodiments. It should be understood that specific embodiments described herein are only used to explain the present invention and do not limit the present invention.

The specific implementation of the present invention is described in detail in conjunction with specific embodiments.

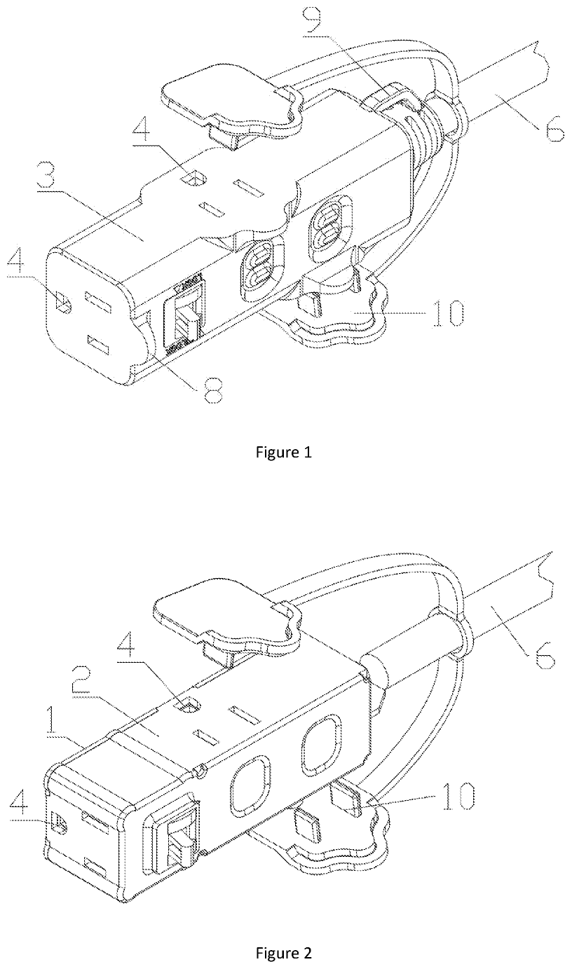

Please refer to FIG. 1 and FIG. 2, an embodiment of the present invention provides a locking structure with dustproof and waterproof caps, comprising:
a bottom panel 1 and a cover panel 2, wherein the bottom panel 1 and the cover panel 2 cooperate mutually and are in snap-fitted installation, wherein outer portions of both the bottom panel 1 and the cover panel 2 are sleeved with a protective cover 3, both the protective cover 3 and the cover panel 2 are provided with socket jacks 4, and the socket jacks 4 are distributed on front and two side portions of the protective cover 3; and a power supply mechanism 5 is installed within the bottom panel 1 and cover panel 2, the power supply mechanism 5 is connected to a cable 6 for electrical energy supply, which enables plugs to be inserted into the power supply mechanism 5 through the socket jacks 4 for energy access; and a front inserting mechanism 7 is arranged on a front portion of the bottom panel and connected with the power supply mechanism, and a plug could be inserted from front socket jacks 4 into the front inserting mechanism 7 and be locked.

When the locking structure with dustproof and waterproof caps is used, firstly a plug on the cable 6 is inserted into a socket, plugs of devices that need electricity are then inserted into the power supply mechanism 5 through the socket jacks 4, and the cable 6 can supply power to the devices through the power supply mechanism 5.

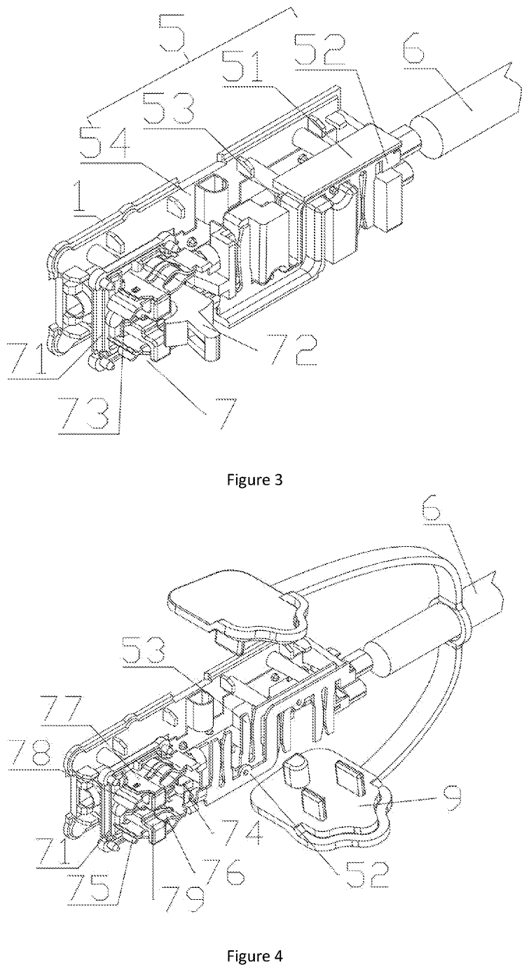

As shown in FIG. 3, in a preferable embodiment of the present invention, the power supply mechanism 5 comprises a support panel 51 arranged in the cover panel 2 and fixedly connected to the bottom panel 1, wherein a first copper sheet 52 and a second copper sheet 53 are respectively installed on both sides of the support panel 51, and the first copper sheet 52 and the second copper sheet 53 are connected to the cable 6, which enables plugs to be inserted into the first copper sheet 52 and the second copper sheet 53 through the socket jacks 4 for power supply; and a grounding panel 54 installed on the bottom panel 1 and connected to the cable 6, enabling plugs to be inserted into the grounding panel 54 through the socket jacks 4 for grounding purposes.

When it needs to use electricity, plugs of the electrical devices are inserted into the socket jacks 4, and the plugs of the electrical devices are inserted into the first copper sheet 52, the second copper sheet 53 and the grounding panel 54. The first copper sheet 52 and the second copper sheet 53 can supply power to the electrical devices, and the grounding panel 54 can be grounded through the cable 6 to ensure the safety of electricity use.

As shown in FIG. 3 and FIG. 4, in a preferable embodiment of the present invention, the front inserting mechanism 7 comprises: a support seat 71 fixedly mounted on a front portion of the bottom panel 1, wherein a lever 72 is rotationally mounted on the support seat 71, a triangular block 73 is fixedly arranged on the lever 72, an elastic sheet 74 mounted on the support seat 71 clamped on a back portion of the lever 72, and the elastic sheet 74 is used to push the lever 72 to reset; a first outer clip 75 fixedly connected to the first copper sheet 52, wherein a first inner clip 76 is fixedly arranged on the first outer clip 75; a second outer clip 77 is fixedly connected to the second copper sheet 53, a second inner clip 78 is fixedly arranged on the second outer clip 77, the first outer clip 75 and the second outer clip 77 could respectively cooperate with the first inner clip 76 and the second inner clip 78 to limit a plug; and push blocks 79 slidably mounted on the support seat 71, wherein the amount of the push blocks 79 is two, and the triangular block 73 contacts the two push blocks 79, so as to push the first outer clip 75 and the second outer clip 77 away mutually to pull out the plug.

When a plug is inserted from front socket jacks in between the first outer clip 75 and the first inner clip 76, and in between the second outer clip 77 and the second inner clip 78, the first outer clip 75 and the second outer clip 77 can press against the plug under the action of their own elastic force, thereby limiting the plug and preventing the plug from being pulled out. If the plug is to be unplugged, the lever 72 is pushed, and the lever 72 is pushed to make the elastic sheet 74 generate a restoring elastic force, and at the same time, the lever 72 drives the triangular block 73 to move upward, the triangular block 73 moves upward to push the two push blocks 79 away from each other, and the two push blocks 79 can push the first outer clip 75 and the second outer clip 77 away from the first inner clip 76 and the second inner clip 78, and the plug can be taken out. After the plug is taken out, the lever 72 is released, and the lever 72 can be reset under the elastic force of the elastic sheet 74. At the same time, the first outer clip 75 and the second outer clip 77 can also be reset under their own elastic force.

As shown in FIG. 1, in a preferable embodiment of the present invention, the locking structure with dustproof and waterproof caps further comprises a power indicator light 7 installed on the protective cover, 3 connected to the first copper sheet 52 and the second copper sheet 53, and used to indicate power supply status of an extension cord; hanging holes 8 fixedly arranged on a rear side of the protective cover 3 for hanging the extension cord; and waterproof caps 9 sleeved outside the cable 6 and arranged in cooperation with the socket jacks, wherein the waterproof caps 9 are able to be inserted into the socket jacks 4 to provide dust and water protection for the first copper sheet 52 and the second copper sheet 53.

The power indicator light 7 can be turned on when the extension cord is energized, so that it can be detected whether t the extension cord is powered on or not. ; the design of the hanging holes 8 can facilitate the hanging of the extension cord, so that it is convenient to use the extension cord in different scenarios; the waterproof caps 9 can seal the socket jacks 4 to prevent the power supply mechanism 5 inside the socket jacks 4 from being disturbed by dust and water. The waterproof caps 9 feature a simple step and slot design. When in use, by lightly pulling edges of the waterproof caps 9, pull-ring structures are formed, which is convenient and labor-saving, and the mold is simple.

In addition, as shown in FIG. 3, front portions of the bottom panel 1 are rotationally installed with toggle levers, which connect to triangular blocks. The triangular blocks are in contact with push blocks that are slidably set within the bottom panel 1. The push blocks are pressed against outer copper sheets, and back portions of the toggle levers are connected to elastic pieces.

When plugs are inserted into copper sheets of the extension cord, the outer copper sheets can lock the plugs in place under own elastic force thereof. When the toggle levers are flipped, the triangular block can be pushed upwards, which in turn pushes push blocks at two sides away from each other, thereby moving the outer copper sheets outward. At this point, the plugs can be pulled out from the extension cord. Once the toggle levers are released, the elastic pieces will return the toggle levers to original positions thereof, and the push blocks can also be reset under the force of the outer copper sheets'elasticity.

The above descriptions are only preferred embodiments of the present invention and are not intended to limit the present invention. Any modifications, equivalent substitutions and improvements made within the spirit and principles of the present invention should be included in the protection scope of the present invention.

1. A locking structure with dustproof and waterproof caps, comprising a bottom panel and a cover panel, wherein the bottom panel and the cover panel cooperate mutually and are in snap-fitted installation, wherein outer portions of both the bottom panel and the cover panel are sleeved with a protective cover, both the protective cover and the cover panel are provided with socket jacks, and the socket jacks are distributed on front and two side portions of the protective cover;
a power supply mechanism is installed within the bottom panel and cover panel and is connected to a cable for electrical energy supply, which enables plugs to be inserted into the power supply mechanism through the socket jacks for energy access; and
a front inserting mechanism is arranged on a front portion of the bottom panel and connected with the power supply mechanism, and a plug could be inserted from front socket jacks into the front inserting mechanism and be locked.

2. The locking structure with dustproof and waterproof caps according to claim 1, wherein the power supply mechanism comprises:
a support panel arranged in the cover panel and fixedly connected to the bottom panel, wherein a first copper sheet and a second copper sheet are respectively installed on both sides of the support panels, and the first copper sheet and the second copper sheet are connected to the cable, which enables plugs to be inserted into the first copper sheet and the second copper sheet through the socket jacks for power supply; and
a grounding panel installed on the bottom panel and connected to the cable, enabling plugs to be inserted into the grounding panel through the socket jacks for grounding purposes.

3. The locking structure with dustproof and waterproof caps according to claim 2, wherein the front inserting mechanism comprises:
a support seat fixedly mounted on a front portion of the bottom panel, wherein a lever is rotationally mounted on the support seat, a triangular block is fixedly arranged on the lever, an elastic sheet mounted on the support seat clamped on a back portion of the lever, and the elastic sheet is used to push the lever to reset;
a first outer clip fixedly connected to the first copper sheet, wherein a first inner clip is fixedly arranged on the first outer clip; a second outer clip is fixedly connected to the second copper sheet, a second inner clip is fixedly arranged on the second outer clip, the first outer clip and the second outer clip could respectively cooperate with the first inner clip and the second inner clip to limit a plug; and
push blocks slidably mounted on the support seat, wherein the amount of the push blocks is two, and the triangular block contacts the two push blocks, so as to push the first outer clip and the second outer clip away mutually to pull out the plug.

4. The locking structure with dustproof and waterproof caps according to claim 2 further comprising:
a power indicator light installed on the protective cover, connected to the first copper sheets and the second copper sheets, and used to indicate power supply status of the extension cord;
hanging holes fixedly arranged on a rear side of the protective cover for hanging the extension cord; and
waterproof caps sleeved outside the cable and arranged in cooperation with the socket jacks, wherein the waterproof caps are able to be inserted into the socket jacks to provide dust and water protection for the first copper sheets and the second copper sheets.
